(19) United States
(12) Patent Application Publication
(10) Pub. No.: US 2026/0340092 A1
(43) Pub. Date: Oct. 29, 2026

(54) Method for Automatically Locking and Unlocking Based on BIOS, and Computer Program Product Thereof

(71) Applicant: INSYDE SOFTWARE CORP., Taipei (TW)

(72) Inventors: Ming-Hsin LIAO, Taipei (TW); Chung-An KAO, Taipei (TW); Hsing-Han HUANG, Taipei (TW); Chih-Kao WANG, Taipei (TW); Yu-Lung CHANG, Taipei (TW)

(73) Assignee: INSYDE SOFTWARE CORP., Taipei (TW)

(21) Appl. No.: 19/655,707

(22) Filed: Apr. 23, 2026

(30) Foreign Application Priority Data
Apr. 29, 2025 (TW) 114116155

(51) Int. Cl. G06F 21/31; G06F 11/30

(52) U.S. Cl. CPC G06F 21/31; G06F 11/3055

(57) ABSTRACT

Disclosed is a method for automatically locking and unlocking based on BIOS and a computer program product. A client-side electronic device is connected to a host-side server via a network, wherein a disconnection condition information is preset and stored. The electronic device obtains internet date time and usage status information, and generates abnormal status information based on the usage status information. The electronic device determines whether the disconnection condition information is satisfied according to the usage status information and the abnormal status information. If yes, a multi-locking procedure is executed; if no, an unlocking procedure is performed. By means of the present disclosure, the electronic device can operate under the BIOS layer in environments without network or GPS signals, making it particularly suitable for equipment with highly confidential specifications, thereby achieving both offline operation and automated security protection.

### CROSS-REFERENCE TO RELATED APPLICATION

This non-provisional application claims priority under 35 U.S.C. § 119(a) to Patent Application No. 114116155 filed in Taiwan, R.O.C. on Apr. 29, 2025, the entire contents of which are hereby incorporated by reference.

### BACKGROUND

### Technical Field

The present disclosure relates to an information processing method and a computer program for a basic input/output system (BIOS) device, and more particularly to a method for automatically locking and unlocking based on a BIOS and a computer program product thereof.

### Related Art

With the rapid advancement of technology, users frequently utilize electronic devices to exchange and store data via networks. Important information stored in electronic devices and remote servers often becomes a target for malicious individuals and criminal groups. This issue not only receives significant attention from industries, but governments worldwide, defense and military units, and financial institutions are also extremely cautious and dare not be negligent.

In the prior art, conventional computer anti-theft systems typically operate in environments with the networks and GPS signals to track and monitor computer devices. By installing anti-theft software on a user computer device and providing a remote host device to achieve functions such as connection, locking, and location tracking via the network. However, the anti-theft software is still frequently subjected to hacker attacks, and this security mechanism even fails in environments without the network or the GPS signals.

However, there are still some other prior arts that mainly set up access control with password verification and utilize encryption to ensure data confidentiality in the user computer device. Nevertheless, it is still difficult to prevent the leakage of passwords and sensitive information, and there are still security concerns due to hacker intrusions. Moreover, when the user computer device is offline or without a network connection, the internal system information can still be directly intruded upon, tampered with, or cracked. Especially when the user computer device belongs to equipment with high-confidentiality specifications (e.g., applied in defense, finance, or semiconductors), there is a need for a new solution that does not require the installation of anti-theft software, protects not merely through passwords, and is adaptable for use in environments without the network or the GPS signals. Therefore, how to provide such a security protection mechanism that can both operates offline and is automatically activated to solve the problems of the prior art. Therefore, there is indeed underscores the necessity of proposing a better solution.

### SUMMARY

In view of the deficiencies of the prior art described above, the main object of the present disclosure is to provide a method for automatically locking and unlocking based on a BIOS and a computer program product, which utilize network and BIOS technologies and can be applicable in offline environments without network or signals, thereby achieving an automated security protection effect.

To achieve the above objective, the main technical measure adopted by the present disclosure is to configure the aforementioned method for automatically locking and unlocking based on a BIOS, implemented by an electronic device connected to a server via a network, wherein disconnection condition information is preset and stored, the method comprising the following steps executed by the electronic device:
obtaining internet date time information and usage status information;
generating abnormal status information based on the usage status information;
determining whether the usage status information and the abnormal status information satisfy the disconnection condition information;
if yes, executing a multi-locking procedure; and
if no, executing an unlocking procedure.

In the aforementioned method, the electronic device is connected to the server to exchange information, and the electronic device obtains the internet date time information and the usage status information, and generates the abnormal status information based on the usage status information. Then, according to the obtained usage status information and the generated abnormal status information, it is determined whether the usage status information and the abnormal status information satisfy the conditions of the disconnection condition information. When the disconnection condition information is satisfied, the electronic device automatically executes the multi-locking procedure. By means of the method for automatically locking and unlocking based on BIOS of the present disclosure, the electronic device may operate under the BIOS layer in environments without network or GPS signals, which is particularly suitable for application to equipment with high-confidentiality specifications, thereby achieving the purpose of both offline operation and automated security protection.

### BRIEF DESCRIPTION OF THE DRAWINGS

FIG. 1 is a system architecture block diagram of an embodiment of the present disclosure;

FIG. 2 is a flowchart of a method for automatically locking/unlocking of an embodiment of the present disclosure;

FIG. 3 is a flowchart of information acquisition and connection status checking of an embodiment of the present disclosure;

FIG. 4 is a flowchart of a preprocessing procedure of a times mode of an embodiment of the present disclosure;

FIG. 5 is a flowchart of shutdown/disable locking of the times mode of an embodiment of the present disclosure;

FIG. 6 is a flowchart of clear locking of the times mode of an embodiment of the present disclosure;

FIG. 7 is a flowchart of a preprocessing procedure of a days/minutes mode of an embodiment of the present disclosure;

FIG. 8 is a flowchart of shutdown/disable locking of the days/minutes mode of an embodiment of the present disclosure;

FIG. 9 is a flowchart of clear locking of the days/minutes mode of an embodiment of the present disclosure;

FIG. 10 is a flowchart of user interface locking of an embodiment of the present disclosure.

### DESCRIPTION OF THE PREFERRED EMBODIMENTS

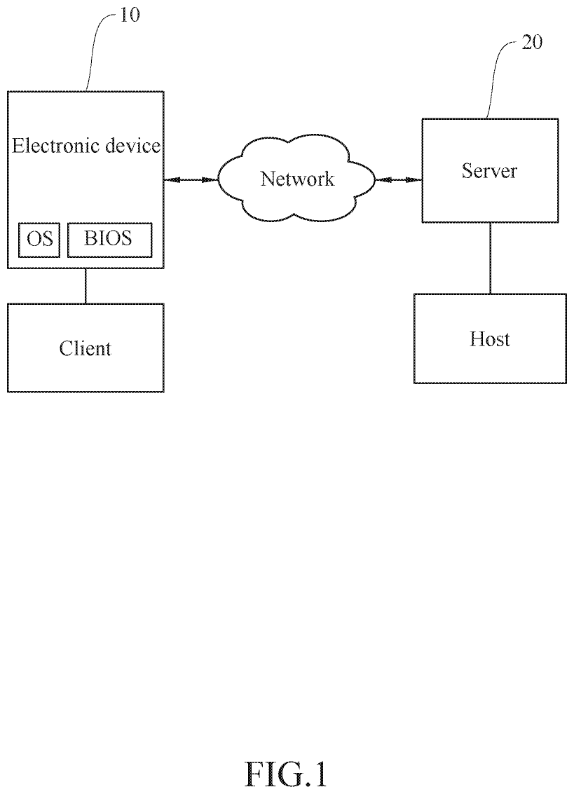

Regarding an embodiment of a method for automatically locking and unlocking based on a BIOS of the present disclosure, referring to FIG. 1, which includes an electronic device 10 and a server 20, wherein the electronic device 10 is connected to the server 20 via a network. The electronic device 10 is disposed at a client for a user to operate and utilize, and the server 20 is disposed at a host, which is typically located at a remote side or a cloud side, which is merely an example here and is not intended to be limiting.

In the present embodiment, the electronic device 10 is installed with an operating system (OS) and a basic input/output system (BIOS), and the electronic device 10 has a built-in storage for storing system data and status information (e.g., various statuses, parameters, and files including hard drive passwords, system locking/disabling statuses, and hard drive data reading/disabling) of the OS/BIOS. The electronic device 10 may be constituted by a personal computer, a desktop computer, a smartphone device, a tablet computer, or a smart storage device. The server 20 may also be constituted by a host computer.

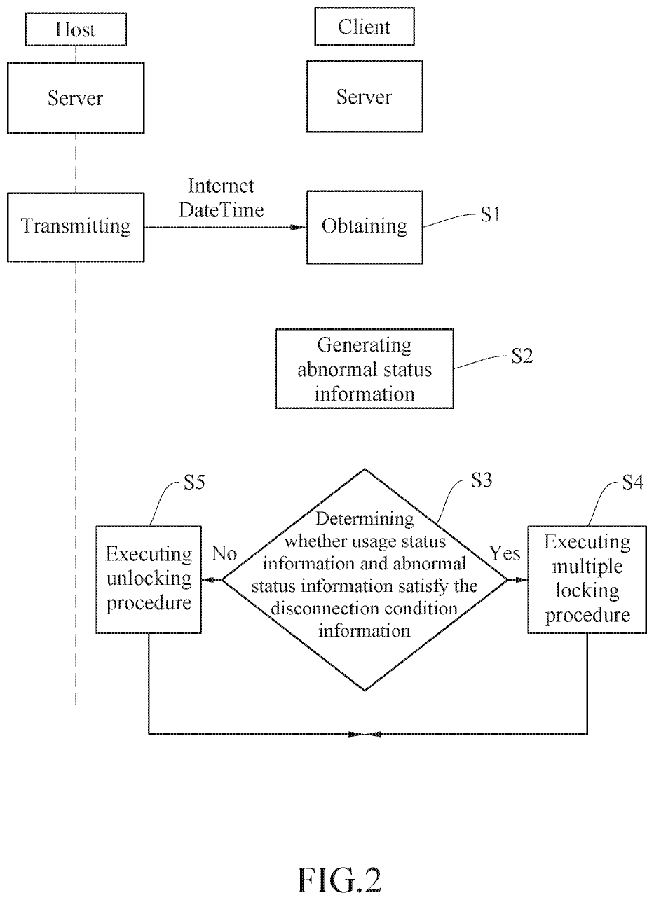

Referring to FIG. 2. In the present embodiment, a usage scenario for automatic locking and unlocking based on BIOS system is provided. Typically, the electronic device 10 and the server 20 are in a power-on state and capable of exchanging information in real time via the network. The server 20 at the host first generates an encrypted current internet date time information, then sets a parameter as Time A, and transmits the current internet date time information (Time A) to the electronic device 10, which may be stored in the storage for confirmation by the electronic device 10 at the client, wherein the electronic device 10 maintains a connected state with the server 20 at the host.

In the present embodiment, in order to enable the electronic device 10 to continuously determine whether it is in a normal or abnormal status after going offline, disconnection condition information is preset and stored in the storage of the electronic device 10. The disconnection condition information comprises times information, days/minutes information, and locked flag status information. In the present embodiment, the disconnection condition information may also be preset and stored in the server 20 at the host first, and then transmitted to the electronic device 10 at the client via the network.

As shown in FIG. 2, after the server 20 at the host transmits the information for ensuring the connected state to the electronic device 10 at the client, the electronic device 10 continuously executes the following automatic locking/unlocking steps:
obtaining the internet date time information and usage status information (S1); in the present embodiment, the usage status information comprises connected flag status information and encrypted locked flag status information;
generating abnormal status information based on the usage status information (S2); in the present embodiment, the abnormal status information comprises times mode information and days/minutes mode information;
determining whether the usage status information and the abnormal status information satisfy preset disconnection condition information (S3);
when the usage status information and the abnormal status information satisfy the preset disconnection condition information, executing a multi-locking procedure (S4); in the present embodiment, the multi-locking procedure comprises a shutdown/disable locking procedure of a times mode, a clear locking procedure of the times mode, a shutdown/disable locking procedure of a days/minutes mode, a clear locking procedure of the days/minutes mode, and a user interface locking procedure; and when the usage status information and the abnormal status information do not satisfy the preset disconnection condition information, executing an unlocking procedure (S5).

Through the steps described above, the electronic device 10 operates under the basic input/output system to be adaptable to environments without network or GPS signals, which is particularly suitable for application to equipment with high-confidentiality specifications, thereby achieving both offline operation and automated security protection.

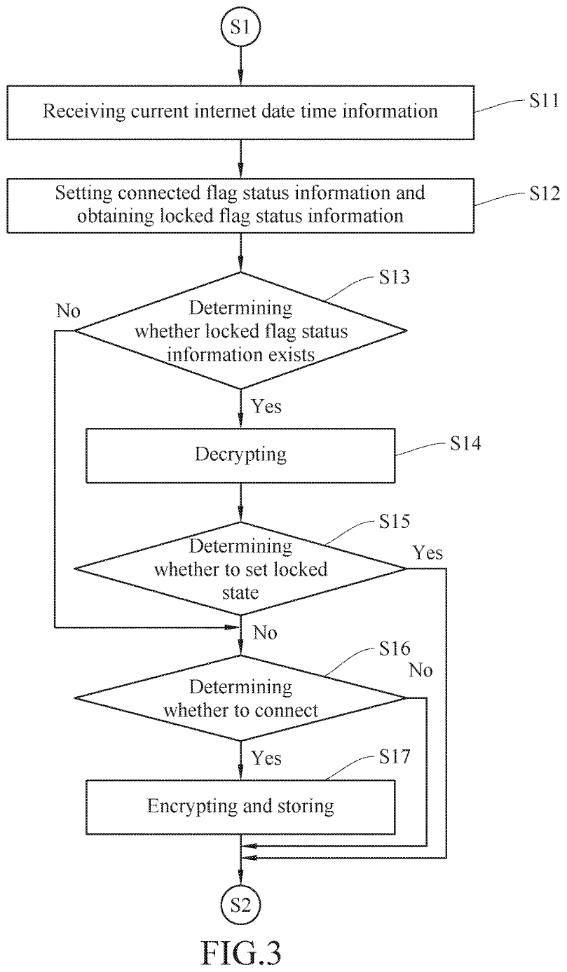

Referring to FIG. 3, which further illustrates an application of the aforementioned information acquisition and connection status checking. In the present embodiment, when the aforementioned steps proceed to the step of obtaining the internet date time information and the usage status information (S1), the electronic device 10 further executes the following sub-steps:
receiving the current internet date time information (S11);
setting connected flag status information of the usage status information, and obtaining locked flag status information of the disconnection condition information stored in the storage (S12);
determining whether the locked flag status information exists (S13);
when the locked flag status information exists, decrypting the locked flag status information (S14);
determining whether decrypted locked flag status information represents a locked status (S15);
when the decrypted locked flag status information does not represent the locked status, representing that the electronic device 10 is not locked, then determining whether the connected flag status information represents a connected state (S16); and
when the connected flag status information represents the connected state, encrypting the connected flag status information and storing it in the storage (S17), and subsequently executing the aforementioned step of generating the abnormal status information based on the usage status information (S2).

Further, as shown in FIG. 3, when the aforementioned sub-steps proceed to the step of determining whether the locked flag status information exists (S13), if no, subsequently executing the aforementioned sub-step of determining whether the connected flag status information represents the connected state (S16).

Further, as shown in FIG. 3, when the aforementioned sub-steps proceed to the step of determining whether the decrypted locked flag status information represents the locked status (S15), if yes, representing that the electronic device 10 is locked, then subsequently executing the aforementioned step of generating the abnormal status information based on the usage status information (S2).

Similarly, as shown in FIG. 3, when the aforementioned sub-steps proceed to the step of determining whether the connected flag status information represents the connected state (S16), if no, representing that the electronic device 10 is not connected, then subsequently executing the aforementioned step of generating the abnormal status information based on the usage status information (S2).

Regarding the automatic locking/unlocking of the present disclosure, it features multi-locking and security defense mechanisms. To explain specific application modes thereof, a times mode and a days/minutes mode are further provided in the present embodiment. Wherein, the times mode has a first type of shutdown/disable locking application, a second type of clear locking application, and a third type of user interface locking application; and the days/minutes mode also has yet another first type of shutdown/disable locking application, yet another second type of clear locking application, and yet another third type of user interface locking application. However, the quantities of the first, second, and third in the present embodiment are merely examples and are not intended to limit the quantities. It should be first clarified that the present disclosure mainly constitutes the multi-locking procedure by respectively providing a plurality of defense functions (e.g., shutdown, disabling, clearing, or UI) under the times mode and/or the days/minutes mode.

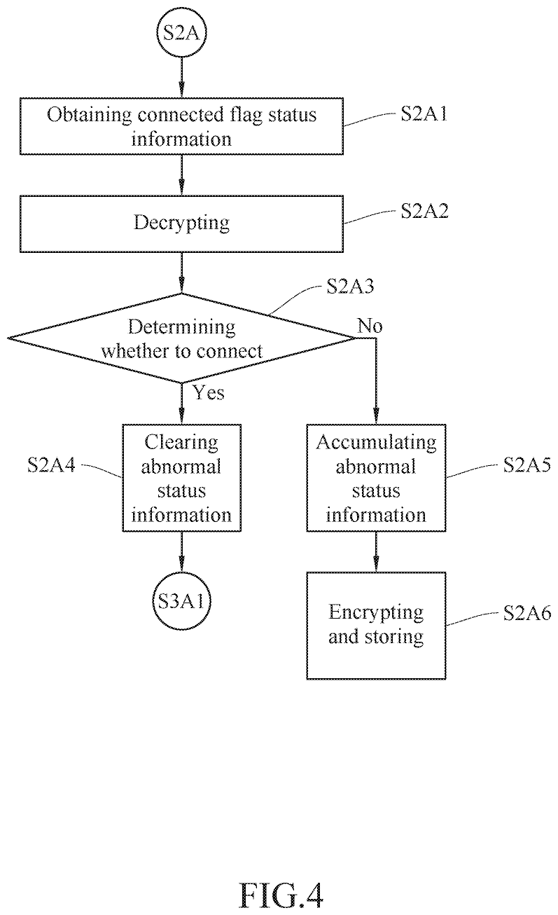

Referring to FIG. 4, which further illustrates an application of the preprocessing procedure of the times mode. In the present embodiment, when the aforementioned steps proceed to the step of generating the abnormal status information based on the usage status information (S2), the electronic device 10 further executes the following sub-steps of the preprocessing procedure of the times mode (S2A):
obtaining the connected flag status information of the usage status information stored in the storage (S2A1);
decrypting the connected flag status information (S2A2);
determining whether the connected flag status information represents the connected state (S2A3);
when the connected flag status information represents the connected state, representing a normal connection, then clearing the abnormal status information (S2A4), which sets the times mode information (Count A) and the connected flag status information of the abnormal status information as “O” and stores them into the storage; and
when the connected flag status information does not represent the connected state, representing an abnormality, then accumulating the times mode information (Count A) of the abnormal status information (S2A5), which comprises: obtaining the times mode information (Count A) of the abnormal status information stored in the storage, and after decrypting, cumulatively adding “1” to the times mode information (Count A), and then encrypting the times mode information (Count A) to be stored in the storage (S2A6).

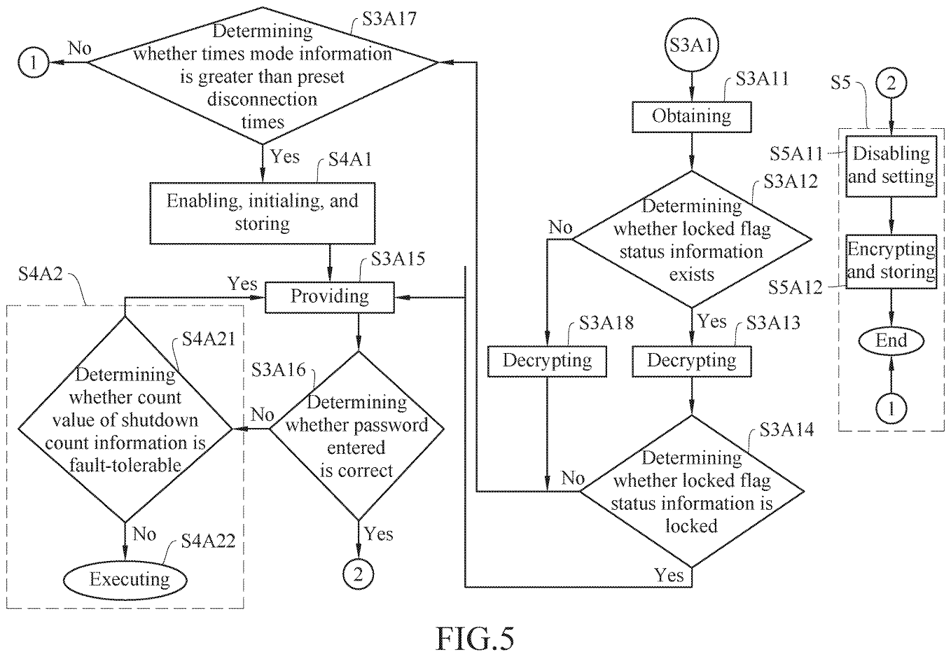

Referring to FIG. 5, which further illustrates the first type of shutdown/disable locking application of the times mode. In the present embodiment, when the aforementioned steps proceed to the step of determining whether the usage status information and the abnormal status information satisfy the preset disconnection condition information (S3), the electronic device 10 further executes the following sub-steps of the shutdown/disable locking of the times mode (S3A1):
obtaining the locked flag status information of the disconnection condition information stored in the storage (S3A11);
determining whether the locked flag status information exists (S3A12); when the locked flag status information exists, decrypting the locked flag status information and the times mode information (Count A) of the abnormal status information (S3A13);
determining whether the locked flag status information represents the locked status (S3A14), for example, being “true”;
when the locked flag status information represents the locked status, representing that the electronic device 10 is locked, and there is no need to determine whether a disconnection has occurred, then directly providing a user interface to input and obtaining a password (S3A15) to unlock the system, and subsequently determining whether the password is correct (S3A16), and when the password is correct, representing that there is no risk, then executing the unlocking procedure (S5); and
when the password is incorrect, representing that the electronic device 10 is not locked, and a disconnection risk may exist, then further determining whether the times mode information (Count A) of the abnormal status information is greater than a preset disconnection times (e.g., N times) (S3A17); and when the times mode information of the abnormal status information is greater than the preset disconnection times, executing the multi-locking procedure (S4).

Further, when the aforementioned step proceeds to the step of determining whether the locked flag status information exists (S3A12), if no, representing that the locked flag status information does not exist and the disconnection risk may exist, then directly decrypting the times mode information (Count A) of the abnormal status information (S3A18), and subsequently executing the aforementioned sub-step of determining whether the times mode information (Count A) of the abnormal status information is greater than the preset disconnection times (S3A17).

As also shown in FIG. 5, in the present embodiment, the multi-locking procedure (S4) further comprises the following sub-step:
when the password of the storage of the electronic device 10 is not enabled, enabling the password of the storage, setting the locked flag status information to the locked status, for example, being “true”, storing the locked flag status information in the storage, and initializing shutdown count information, for example, as “0” (S4A1); and subsequently executing the aforementioned sub-step of directly providing the user interface to input and obtaining the password (S3A15).

As also shown in FIG. 5, in the present embodiment, when the aforementioned step proceeds to the step of determining whether the password is correct (S3A16), if no, representing that the password input by the user is incorrect (S4A2), a count value is set for the shutdown count information. Because a theft risk may exist, then it is further required to determine whether the count value of the shutdown count information is fault-tolerant (e.g., being less than a preset fault-tolerance P times) (S4A21); when the count value of the shutdown count information is less than the preset fault-tolerance P times, then returning to the aforementioned sub-step of directly providing the user interface to input and obtaining the password (S3A15); and when the count value of the shutdown count information is not less than the preset fault-tolerance P times, then executing a system shutdown locking procedure (S4A22).

When the aforementioned steps proceed to the step of determining whether the password is correct (S3A16), if yes, representing that the password is correctly input and the risk is cleared, then executing the unlocking procedure (S5). In the present embodiment, the unlocking procedure (S5) further comprises the following sub-steps:

when the electronic device 10 has been automatically locked, disabling the password of the storage, setting the locked flag status information to an unlocked status, for example, being “false”, and setting the times mode information (Count A) of the abnormal status information, for example, as “0” (S5A11); subsequently, encrypting the locked flag status information and the times mode information (Count A) of the abnormal status information, and storing them in the storage (S5A12).

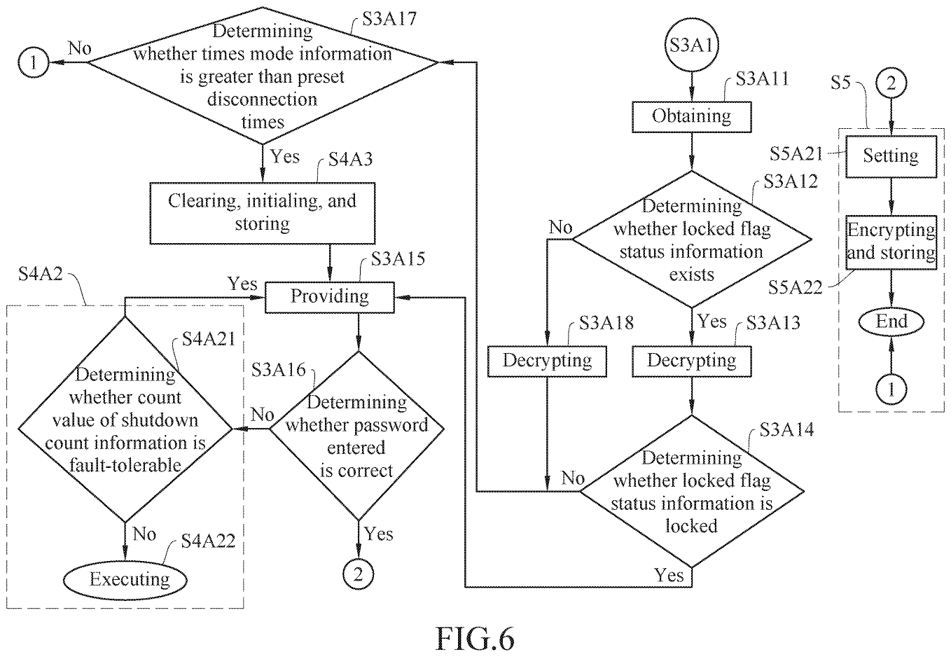

Referring to FIG. 6, which further illustrates the second type of clear locking application of the times mode. In the present embodiment, main steps of the second type of clear locking application of the times mode are substantially identical to the first type of shutdown/disable locking application shown in the aforementioned FIG. 5, except that when the aforementioned steps proceed to the step of determining whether the times mode information (Count A) of the abnormal status information is greater than the preset disconnection times (S3A17), the multi-locking procedure (S4) further comprises the following sub-step:
when the times mode information (Count A) of the abnormal status information is greater than the preset disconnection times, clearing all data in the storage of the electronic device 10, setting the locked flag status information to the locked status, for example, being “true”, encrypting the locked flag status information and to be stored in the storage and initializing the shutdown count information, for example, as “0” (S4A3); and subsequently executing the aforementioned step of directly providing the user interface to input and obtaining the password (S3A15).

As also shown in FIG. 6, in the present embodiment, the unlocking procedure (S5) further comprises the following sub-steps:
setting the locked flag status information to the unlocked status, for example, being “false”, and the times mode information (CountA) of the abnormal status information, for example, as “0” (S5A21); and
subsequently encrypting the locked flag status information and the times mode information (Count A) of the abnormal status information, and storing them in the storage (S5A22).

It should be clarified here that the preprocessing procedure of the days/minutes mode in the present embodiment is different from the aforementioned times mode. In the days/minutes mode, it is further required to obtain a current date time and the backup time of a system stored in the storage of the electronic device 10, and determine whether an abnormality exists or whether an update is required.

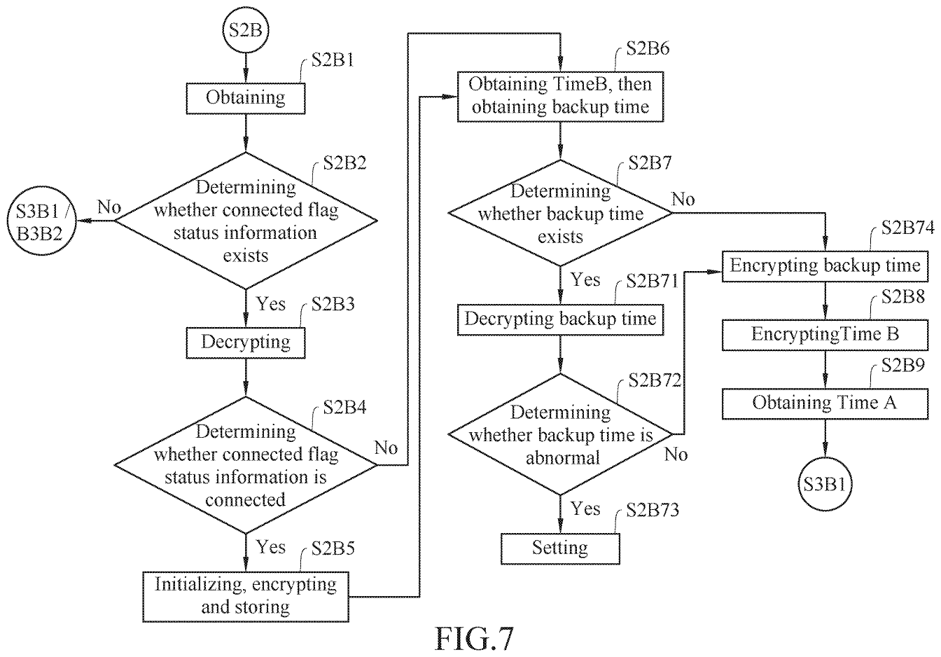

Referring to FIG. 7, which further illustrates a specific application of the preprocessing procedure of the days/minutes mode. In the present embodiment, when the aforementioned steps proceed to the step of generating the abnormal status information based on the usage status information (S2), the electronic device 10 further executes the following sub-steps of the preprocessing procedure of the days/minutes mode (S2B):
obtaining the connected flag status information of the usage status information stored in the storage (S2B1);
determining whether the connected flag status information exists (S2B2), and if yes, representing that the connected flag status information exists, then decrypting the connected flag status information (S2B3);
determining whether the connected flag status information represents the connected state (S2B4), for example, being “true”; and if yes, initializing the connected flag status information, and encrypting the connected flag status information to be stored in the storage (S2B5);
obtaining a current date time of the electronic device 10 and setting a parameter as Time B, and further obtaining a backup time earlier than the current date time from the storage (S2B6);
determining whether the backup time exists (S2B7), and when the backup time exists, then decrypting the backup time (S2B71), and then determining whether a time abnormality occurs (S2B72), for example, the backup time is greater than (i.e., later than) the Time B;
if yes, representing that the time abnormality occurs (S2B73), enabling the password, and setting the locked flag status information to “true” to be encrypted and stored in the storage;
if no, representing that the backup time is earlier than the current Time B, which belongs to a normal time state, then encrypting the backup time to be stored in the storage, thereby achieving an effect of updating time information (S2B74);
encrypting Time B of the current date time, and storing it in the storage (S2B8); and
obtaining the current internet date time information (Time A) from the storage (S2B9), and further, when Time A does not exist, causing the backup time to replace Time A.

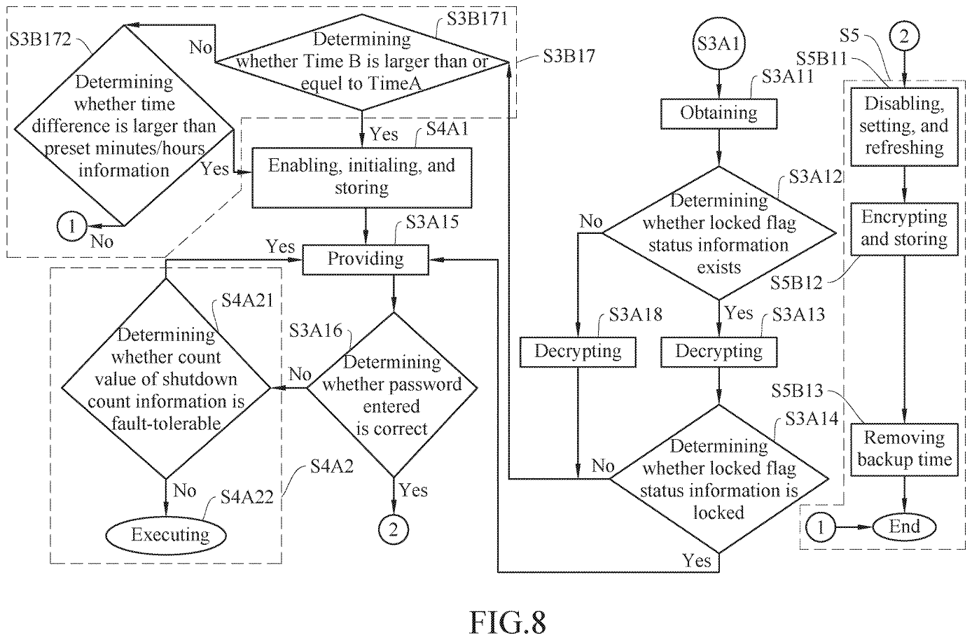

Further, referring to FIG. 8, which specifically illustrates the days/minutes mode features of the first type of shutdown/disable locking application of the days/minutes mode. In the present embodiment, the main steps of the first type of shutdown/disable locking application of the days/minutes mode are substantially identical to the first type of the shutdown/disable locking application shown in the aforementioned FIG. 5, except that the electronic device 10 further executes sub-steps of the shutdown/disable locking of the days/minutes mode (S3B1): when the aforementioned steps proceed to the step of determining whether the locked flag status information represents the locked status (S3A14), if no, representing that the electronic device 10 is not locked and the disconnection risk may exist, then it is further required to determine whether the days/minutes mode information of the abnormal status information is abnormal (S3B17); and when the days/minutes mode information of the abnormal status information is abnormal, then executing the multi-locking procedure (S4, S4A1~S4A3, S4A21, S4A22).

In the present embodiment, as shown in FIG. 8, the specific steps of determining whether the days/minutes mode information of the abnormal status information is abnormal (S3B17) Further Comprises:
according to the current date time (Time B) being greater than or equal to the current internet date time information (Time A), and time difference information between Time B and Time A being greater than preset days information (e.g., M Days) (S3B171), thereby achieving an effect of a disconnection determination within a specific date.

In the present embodiment, as shown in FIG. 8, the specific step of determining whether the days/minutes mode information of the abnormal status information is abnormal (S3B17) may further comprise:
according to time difference information between the current internet datetime information (Time A) and the current date time (Time B) being greater than preset minutes/hours information (e.g., X minutes/hours) (S3B172), thereby achieving an effect of improving accuracy for a disconnection determination within a specific time difference of the same day.

As also shown in FIG. 8, in the present embodiment, when the aforementioned steps proceed to the steps of determining whether the password is correct (S3A16), if yes, representing that the risk is cleared, then executing the unlocking procedure (S5). In the present embodiment, the unlocking procedure (S5) further comprises the following sub-steps:
when the electronic device 10 has been automatically locked, disabling the password of the storage, setting the locked flag status information to the unlocked status, for example, being “false”, and updating (or replacing) the current internet date time information (Time A) to the current date time (Time B) (S5B11), thereby achieving an effect of time synchronization and risk clearance;
subsequently, encrypting the locked flag status information and the current date time (Time B) to be stored in the storage (S5B12); and
removing the encrypted backup time previously stored in the storage (S5B13), thereby making the update mechanism more accurate.

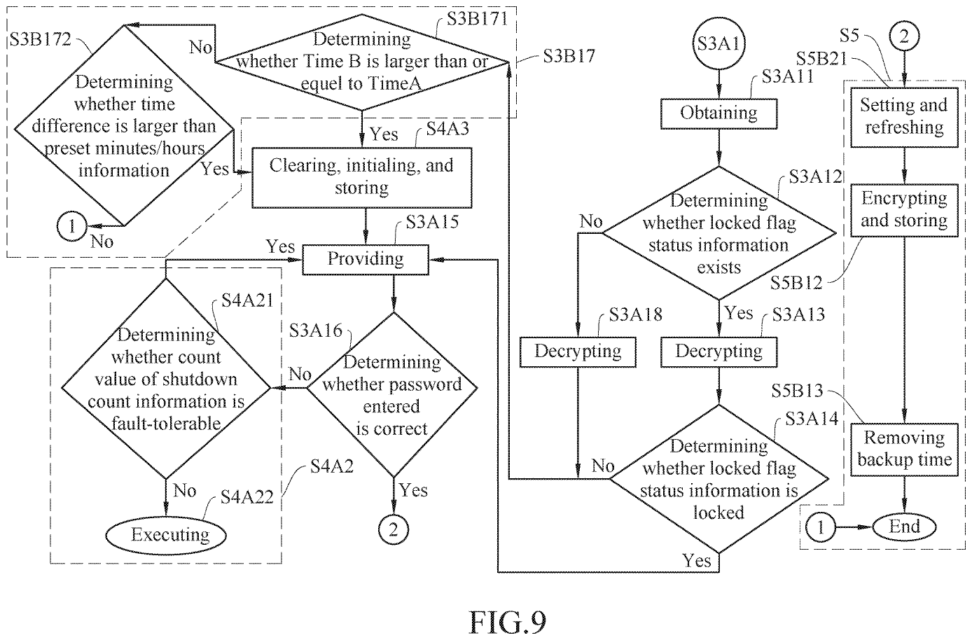

Referring to FIG. 9, which further illustrates the second type of clear locking application of the days/minutes mode. In the present embodiment, main steps of the second type of clear locking application of the days/minutes mode are substantially identical to the first type of the shutdown/disable locking application shown in the aforementioned FIG. 8, except that when the aforementioned step proceeds to the step of determining whether the days/minutes mode information of the abnormal status information is abnormal (S3B17), the electronic device 10 further executes the following sub-step:
when the days/minutes mode information of the abnormal status information is abnormal, clearing all data in the storage of the electronic device 10, setting the locked flag status information to the locked status, for example, being “true”, encrypting the locked flag status information to be stored into the storage, and initializing the shutdown count information, for example, as “0” (S4A3); and subsequently executing the aforementioned step of directly providing the user interface to input and obtaining a password (S3A15).

As also shown in FIG. 9, in the present embodiment, the unlocking procedure (S5) further comprises the following sub-step:
setting the locked flag status information to the unlocked status, for example, being “false”, and updating (or replacing) the current internet date time information (Time A) to the current date time (Time B) (S5B21), thereby achieving an effect of time synchronization and risk clearance; and subsequently executing the aforementioned step of encrypting the locked flag status information and the current date time (Time B) to be stored into the storage (S5B12).

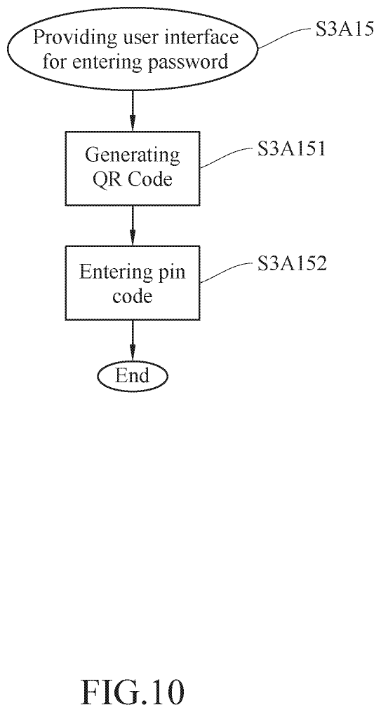

Referring to FIG. 10, which further illustrates the third type of UI locking application applicable to both the times mode and the days/minutes mode. In the present embodiment, when the aforementioned steps proceed to the step of directly providing the user interface to input and obtaining the password (S3A15) to unlock the system, the electronic device 10 further executes the following sub-steps:
generating a QR Code having a locked user interface for the user to scan the QR code with a mobile device (e.g., a smart phone) (S3A151); and
executing a Web application (APP) to generate a pin code for the user to enter as the password (S3A152), thereby further enhancing defense capability of information security through the third type of the UI locking application.

Regarding the embodiment of the method for automatically locking/unlocking based on the BIOS of the present disclosure, during operation of the electronic device 10, the electronic device 10 is equipped with a BIOS system. The usage status information that can be obtained by the electronic device 10 comprises not only the connected flag status information and the encrypted locked flag status information, but also, in the present embodiment, nonce factor information. The nonce factor information may be added to (or appended to) the connected flag status information and the encrypted locked flag status information, so as to increase the confidentiality of the information itself.

Further, in the present embodiment, the electronic device 10 of the client has a device unique universal identification (UUID), such that the various pieces of information exemplified in the aforementioned embodiments, such as the internet date time information, the usage status information (e.g., connected flag information or encrypted locked flag information), the abnormal status information (e.g., Count A or Time B), the BIOS current date time, or the BIOS backup time, are combined with the UUID, thereby making both devices and information more secure.

Moreover, in this embodiment, during the BIOS Ready-to-Boot phase, the electronic device 10 may set the abnormal status information (Count A/Time B), the BIOS backup time (Time B), and the usage status information as a read-only UEFI (unified extensible firmware interface) variable, thereby enhancing information security. When the electronic device 10 is in the BIOS state, it retrieves a previous BIOS date/time from a secure area of the storage to check the current BIOS date/time. When the current BIOS date/time is less than or equal to the previous BIOS date/time, the system will be locked because the current BIOS date/time cannot be trusted. However, in summary, the present disclosure may also be implemented as a computer program product installed in a client computer device to execute the specific applications in the aforementioned embodiments of the method for automatically locking/unlocking based on the BIOS.

1. A method for automatically locking and unlocking based on a basic input/output system (BIOS), implemented by an electronic device connected to a server via a network, wherein disconnection condition information is preset and stored, the method comprising the following steps executed by the electronic device:
obtaining internet date time information and usage status information;
generating abnormal status information based on the usage status information;
determining whether the usage status information and the abnormal status information satisfy the disconnection condition information;
if yes, executing a multi-locking procedure; and
if no, executing an unlocking procedure.

2. The method for automatically locking and unlocking based on the BIOS of claim 1, wherein the disconnection condition information comprises times information or days/minutes information.

3. The method for automatically locking and unlocking based on the BIOS of claim 1, wherein the usage status information comprises connected flag status information or locked flag status information.

4. The method for automatically locking and unlocking based on the BIOS of claim 2, wherein the usage status information comprises connected flag status information or locked flag status information.

5. The method for automatically locking and unlocking based on the BIOS of claim 1, wherein the abnormal status information comprises times mode information or timing days/minutes mode information.

6. The method for automatically locking and unlocking based on the BIOS of claim 2, wherein the abnormal status information comprises times mode information or days/minutes mode information.

7. The method for automatically locking and unlocking based on the BIOS of claim 1, wherein the multi-locking procedure comprises a shutdown/disable locking procedure of a times mode, a clear locking procedure of the times mode, a shutdown/disable locking procedure of a days/minutes mode, a clear locking procedure of the days/minutes mode, or a user interface locking procedure.

8. The method for automatically locking and unlocking based on the BIOS of claim 1, wherein when the step of obtaining internet date time information and the usage status information is executed, the method further comprises executing the following sub-steps:
receiving current internet date time information; and
determining whether the electronic device is locked and a connection is established, and continuing to execute the step of generating the abnormal status information based on the usage status information according to a determination result.

9. The method for automatically locking and unlocking based on the BIOS of claim 1, further comprising: providing a times mode, wherein the times mode comprises a shutdown/disable locking application, a clear locking application, or a user interface locking application.

10. The method for automatically locking and unlocking based on the BIOS of claim 1, further comprising: providing a days/minutes mode, wherein the days/minutes mode comprises a shutdown/disable locking application, a clear locking application, or a user interface locking application.

11. The method for automatically locking and unlocking based on the BIOS of claim 1, wherein when the step of generating the abnormal status information based on the usage status information is executed, the method further comprises:
executing a preprocessing procedure of a times mode to clear or accumulate the abnormal status information.

12. The method for automatically locking and unlocking based on the BIOS of claim 1, wherein when the steps of determining whether the usage status information and the abnormal status information satisfy the disconnection condition information, and if yes, executing the multi-locking procedure are executed, the method further comprises executing a sub-step of a shutdown/disable locking procedure of a times mode:
when the electronic device is not locked, determining whether times mode information of the abnormal status information is greater than a preset disconnection times;
when the times mode information of the abnormal status information is greater than the preset disconnection times, setting a locked state;
providing a user interface for entering a password;
when the password entered is incorrect, determining whether to execute a system shutdown locking procedure; and
when the password entered is correct, executing the unlocking procedure.

13. The method for automatically locking and unlocking based on the BIOS of claim 12, wherein when the step of when the electronic device is not locked, determining whether the times mode information of the abnormal status information is greater than the preset disconnection times is executed, the method further comprises the following step:
when the times mode information of the abnormal status information is greater than the preset disconnection times, clearing all data of storage of the electronic device.

14. The method for automatically locking and unlocking based on the BIOS of claim 1, wherein when the step of generating the abnormal status information based on the usage status information is executed, the method further comprises:
executing a preprocessing procedure of a days/minutes mode to determine whether a time abnormality occurs, and when the time abnormality does not occur, performing an update.

15. The method for automatically locking and unlocking based on the BIOS of claim 1, wherein when the steps of determining whether the usage status information and the abnormal status information satisfy the disconnection condition information, and if yes, executing the multi-locking procedure are executed, the method further comprises executing a sub-step of a shutdown/disable locking application in a days/minutes mode:
when the electronic device is not locked, determining whether days/minutes mode information of the abnormal status information is abnormal;
when the days/minutes mode information of the abnormal status information is abnormal, setting a locked state;
providing a user interface for entering a password;
when the password entered is incorrect, determining whether to execute a system shutdown locking procedure; and
when the password entered is correct, executing the unlocking procedure.

16. The method for automatically locking and unlocking based on the BIOS of claim 15, wherein the step of determining whether the days/minutes mode information of the abnormal status information is abnormal further comprises:
determining whether a time difference is greater than preset days information.

17. The method for automatically locking and unlocking based on the BIOS of claim 15, wherein the step of determining whether the days/minutes mode information of the abnormal status information is abnormal further comprises:
determining whether a time difference is greater than preset minutes/hours information.

18. The method for automatically locking and unlocking based on the BIOS of claim 16, wherein the step of determining whether the days/minutes mode information of the abnormal status information is abnormal further comprises:
when the days/minutes mode information of the abnormal status information is abnormal, clearing all data of storage of the electronic device.

19. The method for automatically locking and unlocking based on the BIOS of claim 17, wherein the step of determining whether the days/minutes mode information of the abnormal status information is abnormal further comprises:
when the days/minutes mode information of the abnormal status information is abnormal, clearing all data of storage of the electronic device.

20. The method for automatically locking and unlocking based on the BIOS of claim 12, wherein when the step of providing the user interface for entering the password is executed, the method further comprises the following steps:
generating a QR code having a locked user interface; and
entering a pin code as the password.

21. The method for automatically locking and unlocking based on the BIOS of claim 15, wherein when the step of providing the user interface for entering the password is executed, the method further comprises the following steps:
generating a QR code having a locked user interface; and
entering a pin code as the password.

22. The method for automatically locking and unlocking based on the BIOS of claim 3, wherein the usage status information further comprises nonce factor information, and the nonce factor information is incorporated into the connected flag status information and the locked flag status information.

23. The method for automatically locking and unlocking based on the BIOS of claim 4, wherein the usage status information further comprises nonce factor information, and the nonce factor information is incorporated into the connected flag status information and the locked flag status information.

24. The method for automatically locking and unlocking based on the BIOS of claim 3, wherein the electronic device has a device unique universal identifier (UUID);
and the abnormal status information and the usage status information are set as a read-only unified extensible firmware interface (UEFI) variable.

25. The method for automatically locking and unlocking based on the BIOS of claim 4, wherein the electronic device has a device unique universal identifier; and the abnormal status information and the usage status information are set as a read-only unified extensible firmware interface variable.

26. A computer program product installed in a client-side computer device, wherein the computer program product executes the method for automatically locking and unlocking based on the BIOS of claim 1.
